(19) United States
(12) Patent Application Publication
(10) Pub. No.: US 2024/0271384 A1
(43) Pub. Date: Aug. 15, 2024

(54) Systems and Methods for Preventing Cracks in Home Foundation

(71) Applicant: STATE FARM MUTUAL AUTOMOBILE INSURANCE COMPANY, Bloomington, IL (US)

(72) Inventor: Brian N. Harvey, Bloomington, IL (US)

(21) Appl. No.: 18/113,269

(22) Filed: Feb. 23, 2023

Related U.S. Application Data
(60) Provisional application No. 63/445,915, filed on Feb. 15, 2023.

(51) Int. Cl. E02D 31/10; G01M 5/00; G05B 13/02; G05B 13/04; G08B 21/18

(52) U.S. Cl. CPC E02D 31/10; G01M 5/0041; G05B 13/0265; G05B 13/048; G08B 21/18

(57) ABSTRACT

Systems and methods for preventing cracks in the foundation of a building are provided. Exemplary techniques may include monitoring pressure measurements captured by one or more pressure sensors configured to be positioned against and/or located on a foundation of a building over a period of time; analyzing the pressure measurements captured by the one or more pressure sensors over the period of time in order to determine that the foundation of the building has moved away from the one or more pressure sensors over the period of time; and triggering an alert indicating that the foundation of the building has moved away from the one or more pressure sensors over the period of time.

### CROSS-REFERENCE TO RELATED APPLICATIONS

The present disclosure claims priority to U.S. Provisional Application No. 63/445,915, entitled “Systems and methods for preventing cracks in home foundation.” and filed Feb. 15, 2023, the entirety of which is incorporated by reference herein.

### FIELD OF THE INVENTION

The present disclosure generally relates to smart home technologies, and more particularly, to technologies for preventing cracks in the foundation of a home or other building.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In some areas, the ground may become very dry due to drought conditions or seasonal rain patterns. This may lead to basement walls cracking as the earth pulls away from them taking their supporting properties with it. It may be common practice to water the ground around one's home in these locations. It may also be common for a homeowner to forget to turn off the water, wasting a valuable resource in drought-affected areas. Conventional techniques may include additional drawbacks, ineffectiveness, inefficiencies, and/or encumbrances, as well.

### SUMMARY

The present disclosure generally relates to smart home technologies, and more particularly, to technologies for preventing cracks in the foundation of a home or other building. Exemplary systems and methods are configured for preventing cracks in the foundation of a building are provided. Exemplary techniques may include monitoring pressure measurements captured (such as over a period of time) by one or more pressure sensors configured to be positioned against a foundation, and/or located on, along, or even within the foundation.

In one aspect, a computer-implemented method for preventing cracks in the foundation of a home or other building may be provided. The method may include (1) monitoring, by one or more processors, pressure measurements captured by one or more pressure sensors configured to be positioned against a foundation of a building (and/or positioned or located on or along or within the building foundation) over a period of time; (2) analyzing, by the one or more processors, the pressure measurements captured by the one or more pressure sensors over the period of time in order to determine that the foundation of the building has moved away from the one or more pressure sensors over the period of time; and/or (3) triggering, by the one or more processors, an alert indicating that the foundation of the building has moved away from the one or more pressure sensors over the period of time. The method may include additional, less, or alternate actions, including those discussed elsewhere herein.

In another aspect, a computer system for preventing cracks in the foundation of a home or other building may be provided. The computer system may include one or more pressure sensors configured to be positioned against a foundation of a building (or otherwise positioned or located in the vicinity or proximity of the building foundation and/or along or within the building foundation) and one or more processors configured to interface with the one or more pressure sensors, and a memory storing computer-executable instructions that, when executed by the one or more processors, cause the one or more processors to: (1) monitor pressure measurements captured by the one or more pressure sensors over a period of time; (2) analyze the pressure measurements captured by the one or more pressure sensors over the period of time in order to determine that the foundation of the building has moved away from the one or more pressure sensors over the period of time; and/or (3) trigger an alert indicating that the foundation of the building has moved away from the one or more pressure sensors over the period of time. The system may include additional, less, or alternate functionality, including that discussed elsewhere herein.

In still another aspect, a non-transitory computer-readable storage medium storing computer-readable instructions for preventing cracks in the foundation of a home or other building may be provided. The computer-readable instructions, when executed by one or more processors configured to interface with one or more pressure sensors, may cause the one or more processors to: (1) monitor pressure measurements captured by the one or more pressure sensors over a period of time; (2) analyze the pressure measurements captured by the one or more pressure sensors over the period of time in order to determine that the foundation of the building has moved away from the one or more pressure sensors over the period of time; and/or (3) trigger an alert indicating that the foundation of the building has moved away from the one or more pressure sensors over the period of time. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for preventing cracks in the foundation of a home or other building, according to one embodiment;

FIG. 2A illustrates an exemplary positioning of sensors against an intact foundation of a building, and an exemplary water system, according to one embodiment;

FIG. 2B illustrates an exemplary positioning of sensors against a cracked foundation of a building, and an exemplary water system, according to one embodiment;

FIG. 3 depicts a flow diagram of an exemplary computer-implemented method for preventing cracks in the foundation of a home or other building, according to one embodiment; and

FIG. 4 depicts an exemplary computing system in which the techniques described herein may be implemented, according to one embodiment.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

Using the techniques provided herein, a plurality of dry ground pressure sensors, each including a thin pressure-sensing probe, may be inserted in the ground against and/or along the foundation of a house in a vertical orientation in strategic locations around the perimeter of foundation of new homes or as a retro-fit kit for existing homes.

As the ground becomes dry and pulls away from the foundation (and, accordingly, the pressure-sensing probes), the techniques provided herein may include triggering one or more mitigating steps. For instance, the techniques provided herein may include sending an alert to the homeowner, who might then saturate the ground to prevent the risk of their basement walls cracking. As another example, the techniques provided herein may include triggering a smart valve connected to a watering system (e.g., a sprinkler system, a watering hose with perforations installed around the perimeter of the foundation of the home, etc.) to saturate the ground, i.e., in order to prevent the ground from becoming too dry in the first place without any action on the part of the homeowner. The techniques provided herein may include turning the water off after a period of time, or when the sensors detect the ground is saturated enough to prevent damage to the foundation.

In some examples, the techniques provided herein may access weather data, in order prevent the system from watering the ground if rain is expected within a reasonable amount of time (i.e., to avoid wasting water). If the forecast is incorrect, and it does not rain within the specified time and weather markers are not favorable for rain in the local area, the system can then water the ground or alert the homeowner or both. Additionally, some sensors may be incorporated in the probes, and data from those sensors may be used to determine whether rain is likely in the local area. These may be temperature sensors, barometers, etc., and may use a weather model to predict the likelihood of rain.

These probes and their associated sensors may include built in communication capabilities, or may connect to a device that has capabilities to connect them to a smart home system or the home Wi-Fi system. In any case, the present techniques may include a mobile application via which users may configure the sensors and set up a means of sending alerts (e.g., text message, mobile device alert, email, phone call, etc.). Additionally, in some examples, a mobile application may provide a status of ground pressure over time and potential for this risk. This data may be collected and used to build and refine a model to help protect against this type of risk for other users.

### Exemplary System

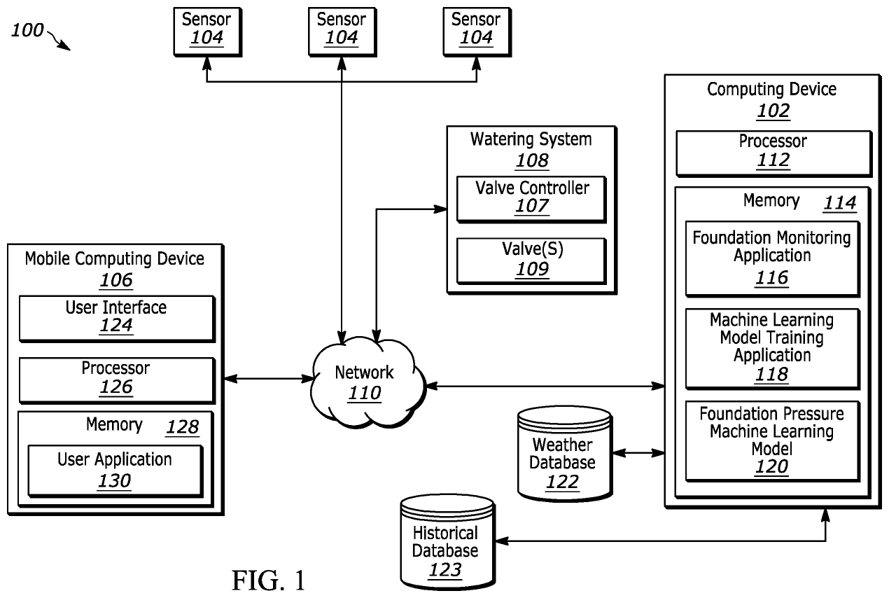

Referring now to the drawings, FIG. 1 depicts an exemplary computer system 100 for preventing cracks in the foundation of a home or other building, according to one embodiment. The high-level architecture illustrated in FIG. 1 may include both hardware and software applications, as well as various data communications channels for communicating data between the various hardware and software components, as is described below.

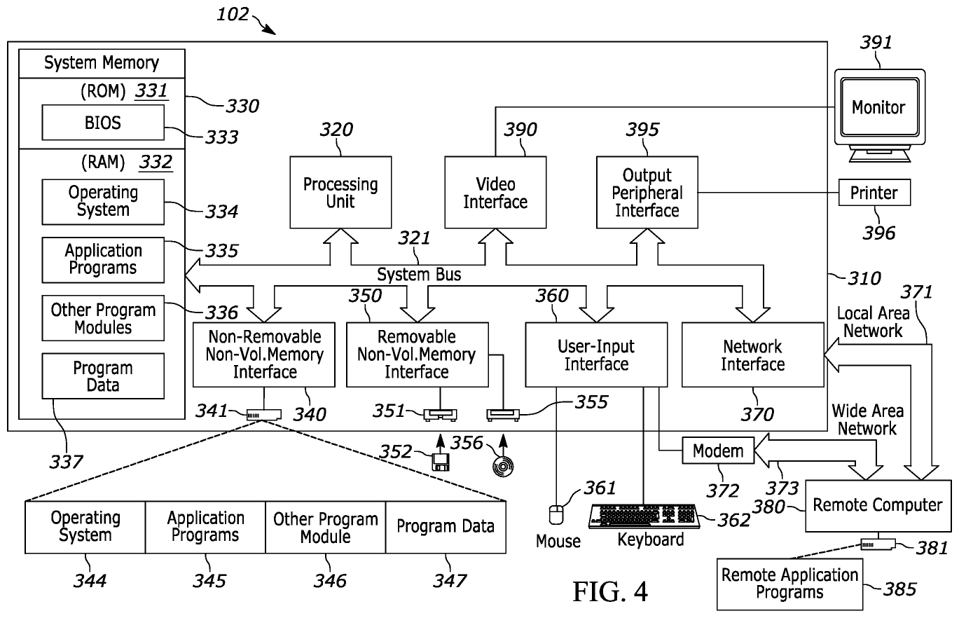

The system 100 may include a computing system 102, which is described in greater detail below with respect to FIG. 4, as well as one or more sensors 104, one or more mobile computing devices 106 (which may include, e.g., smart phones, smart watches or fitness tracker devices, tablets, laptops, virtual reality headsets, smart or augmented reality glasses, wearables, etc.), and in some examples, a water system 108, which may include a valve controller 107 and one or more valves 109. The sensors 104 may be configured to measure pressure, moisture, temperature, and/or various other types of data, in various embodiments. For instance, the sensors 104 may include pressure sensors, moisture sensors, temperature sensors, barometers, and/or various other types of sensors.

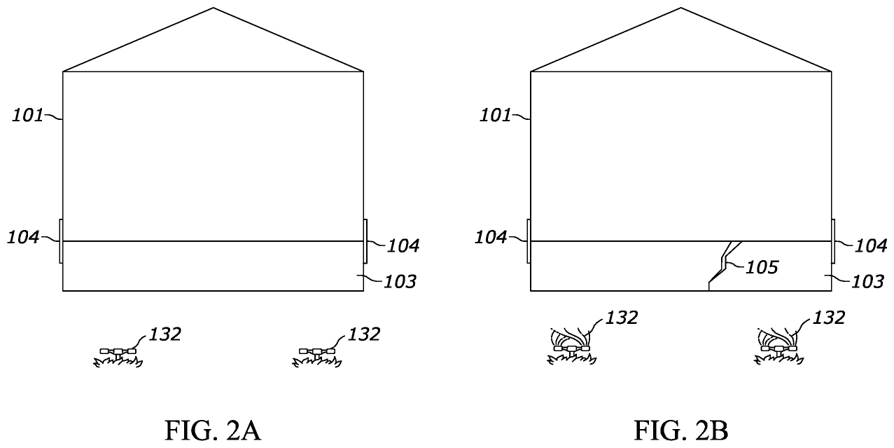

For instance, referring now to FIGS. 2A and 2B, one or more of the sensors 104 may be positioned in the area of a building 101, including against the foundation 103 of the building 101.

Referring back to FIG. 1, the computing system 102, sensors 104, mobile computing device(s) 106, and water system 108 may be configured to communicate with one another via a wired or wireless computer network 110. To facilitate such communications the computing system 102, sensors 104, mobile computing device(s) 106, and water systems 108 may each respectively comprise a wireless transceiver to receive and transmit wireless communications.

Although one computing system 102, three sensors 104, one mobile computing device 106, one water system 108, and one network 110 are shown in FIG. 1, any number of such computing systems 102, sensors 104, mobile devices 106, water systems 108, and networks 110 may be included in various embodiments.

In some embodiments, the computing system 102 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 112 (e.g., CPUs) as well as one or more computer memories 114.

Memories 114 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 114 may store an operating system (OS) (e.g., Microsoft Windows, Linux, UNIX, etc.) capable of facilitating the functionalities, apps, methods, or other software as discussed herein. Memorie(s) 114 may also store a foundation monitoring application 116, a foundation pressure machine learning model 118, and/or a foundation pressure machine learning model training application 120.

Additionally, or alternatively, the memorie(s) 114 may store and/or access data, including weather data and historical data, including historical sensor data and/or data related to historical foundation cracks. The weather data may also be stored in a weather database 122, which may be accessible or otherwise communicatively coupled to the computing system 102. Similarly, the historical data may also be stored in a historical database 123. In some embodiments, the weather data, historical data, or other data from various sources may be stored on one or more blockchains or distributed ledgers.

Executing the foundation monitoring application 116 may include monitoring data captured by pressure sensors 104 positioned against the foundation 103 of a building 101 over a period of time. For instance, the foundation monitoring application 116 may analyze the data from the pressure sensors 104 over the period of time to determine whether, and to what extent, the pressure applied by the foundation 103 of the building 101 to the sensors 104 changes over the period of time.

Generally speaking, a decrease in the pressure applied by the foundation 103 of the building 101 and/or the ground adjacent to the foundation 103 of the building 101 to the sensors 104 over time may indicate that the foundation 103 of the building 101 and/or the ground adjacent to the foundation 103 of the building 101 is pulling away from the sensors 104, which may be predictive or indicative of a current or future crack 105 in the foundation. For example, FIG. 2A illustrates an example of an initial foundation 103 of a building 101. The foundation 103 of the building 101, and/or the ground adjacent to the foundation 103 of the building 101 which may apply a first amount of pressure to the sensors 104. FIG. 2B illustrates an example of a foundation 103 of a building 101 including a crack 105. The foundation 103 of the building 101, and/or the ground adjacent to the foundation 103 of the building 103 may apply a second, decreased, amount of pressure to the sensors 104, as the ground and the foundation pull away from one another, eventually resulting in the crack 105. Upon determining that the pressure measured by the pressure sensors 104 has decreased over a period of time (e.g., upon determining that the pressure measured by the pressure sensors 104 has decreased by greater than a threshold amount, determining that the pressure measured by the pressure sensors 104 has decreased at a rate greater than a threshold rate, etc., over the period of time), the foundation monitoring application 116 may generate an alert.

In some examples, the foundation monitoring application 116 may monitor the data captured by the pressure sensors 104 collectively, and may generate the alert based upon, for instance, an average or other collective pressure as measured by the pressure sensors 104. Additionally, in some examples, the foundation monitoring application 116 may monitor the data captured by the pressure sensors 104 individually or based upon zones or groups of pressure sensors 104, e.g., based upon the locations of the various pressure sensors 104 with respect to the foundation 103 of the building 101. In such cases, the foundation monitoring application 116 may additionally or alternatively generate an alert based upon changes in pressure associated with individual pressure sensors 104 or groups of pressure sensors 104. For instance, the alert may indicate that a particular portion of the foundation 103 of the building 101 and/or the ground adjacent to the foundation 103 of the building 101 is pulling away from respective pressure sensors 104 located at or near that portion of the foundation 103 of the building 101.

In some examples, the foundation monitoring application 116 may generate a notification to be presented by a user of the mobile computing device 106 based upon generating the alert, and may send the generated notification to the mobile computing device 106, e.g., via the network 110.

Moreover, in some examples, the foundation monitoring application 116 may cause the watering system 108 to open one or more valves 109 based upon generating the alert. For instance, the foundation monitoring application 116 may send a signal indicating the alert to the watering system 108, e.g., via the network 110. In response to receiving the signal, the valve controller 107 of the watering system 108 may cause one or more valves 109 to open, such that water may be provided to the foundation 103 of the building 101 and/or to the ground adjacent to the foundation 103 of the building 101. For instance, as shown in FIGS. 2A and 2B, the valves 109 may be associated with one or more sprinklers 132, which may provide water to the foundation 103 of the building 101 and/or to the ground adjacent to the foundation 103 of the building 101 (as shown in FIG. 2B) when the valves 109 are open. In other examples, the valves 109 may be associated with one or more watering hoses (not shown), which may provide water to the foundation 103 of the building 101 and/or to the ground adjacent to the foundation 103 of the building 101 when the valves 109 are open.

Furthermore, in examples in which the alert relates to a particular portion of the foundation 103 of the building 101 and/or to a particular portion of the ground adjacent to the foundation 103 of the building 101, the foundation monitoring application 116 may send a signal causing the watering system 108 to open particular valves 109 based upon the locations of the valves 109 (and/or based upon the locations of sprinklers 132 or hoses associated with the valves 109) with respect to the location of the portion of the foundation 103 and/or to a particular portion of the ground adjacent to the foundation 103 of the building 101. That is, in some examples, the foundation monitoring application 116 may send a signal causing the watering system 108 to open particular valves 109 and close (or not open) other valves 109, in order to provide water to the particular portion of the foundation 103 of the building and/or to the particular portion of the ground adjacent to the foundation 103 of the building 101 and not to other portions of the foundation 103 of the building 101 and/or other portions of the ground adjacent to the foundation 103 of the building 101.

Additionally, the foundation monitoring application 116 may in some cases determine whether to send a signal causing the watering system 108 to open one or more valves 109 based at least in part on predicted weather conditions. For instance, in some examples, the foundation monitoring application 116 may access weather data, e.g., from a weather database 122.

The weather data may include indications of predicted weather conditions in the area where the building 101 is located over a period of time after the triggering of the alert. Additionally, or alternatively, the sensors 104 may include sensors configured to capture data related to weather prediction (e.g., temperature sensors, barometers, etc.) associated with the arca where the building 101 is located, and the foundation monitoring application 116 may generate weather predictions based upon this captured data related to weather prediction.

If the weather data indicates that precipitation is predicted over the period of time after the triggering of the alert (and/or if the weather data indicates that a certain amount of precipitation is predicted over the period of time after the triggering of the alert, e.g., greater than a threshold amount of precipitation), the foundation monitoring application 116 may not cause the watering system 108 to open the one or more valves 109 (or may cause the watering system 108 to close the one or more valves 109) despite the triggering of the alert. That is, when the weather data indicates that precipitation is already predicted over a period of time after the triggering of the alert, the one or more valves 109 may not need to be opened in order to provide water to the foundation 103 of the building 101 and/or to the ground adjacent to the foundation 103 of the building 101, and water may be conserved over that period of time.

Similarly, the foundation monitoring application 116 may in some cases determine whether to send a signal causing the watering system 108 to open or close one or more valves 109 based at least in part on moisture levels associated with the area in which the building 101 is located, as measured by the sensors 104, which may include one or more moisture sensors. For instance, if the moisture levels measured by the sensors 104 indicates that a moisture level associated with the area in which the building 101 is located, the foundation monitoring application 116 may not cause the watering system 108 to open the one or more valves 109 (or may cause the watering system 108 to close the one or more valves 109) despite the triggering of the alert. That is, when the moisture level associated with the area in which the building 101 is located are already greater than a threshold level during a period of time after the triggering of the alert, the one or more valves 109 may not need to be opened in order to provide water to the foundation 103 of the building 101, and water may be conserved over that period of time.

Furthermore, in some examples, the foundation monitoring application 116 generating the alert (and/or sending a signal to the watering system 108 to open or close the one or more valves 109) may be based upon applying a trained foundation pressure machine learning model 118 to the data captured by the various sensors 104.

In some examples, the foundation pressure machine learning model 118 may be executed on the computing system 102, while in other examples the foundation pressure machine learning model 118 may be executed on another computing system, separate from the computing system 102. For instance, the computing system 102 may send the data captured by the various sensors 104 to another computing system, where the trained foundation pressure machine learning model 118 is applied to the data captured by the various sensors 104, and the other computing system may send a prediction or identification of a crack in the foundation 103 of a building 101, based upon applying the trained foundation pressure machine learning model 118 to the data captured by the various sensors 104 associated with the foundation 103 of the building 101, to the computing system 102. Moreover, in some examples, the foundation pressure machine learning model 118 may be trained by a foundation pressure machine learning model training application 120 executing on the computing system 102, while in other examples, the foundation pressure machine learning model 118 may be trained by a machine learning model training application executing on another computing system, separate from the computing system 102.

Whether the foundation pressure machine learning model 118 is trained on the computing system 102 or elsewhere, the foundation pressure machine learning model 118 may be trained by the foundation pressure machine learning model training application 120 using training data corresponding to historical sensor data associated with historical buildings, and historical indications of cracks in foundations associated with the historical buildings. The trained foundation pressure machine learning model 118 may then be applied to the data captured by the various sensors 104 associated with the foundation 103 of a building 101 in order to predict or identify a crack in the foundation 103 of the building 101.

In various aspects, the foundation pressure machine learning model 118 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the foundation pressure machine learning model 118 may comprise a library or package executed on the computing system 102 (or other computing devices not shown in FIG. 1). For example, such libraries may include the TENSORFLOW based library, the PYTORCH library, and/or the SCIKIT-LEARN Python library.

Machine learning may involve identifying and recognizing patterns in existing data (such as training a model based historical sensor data associated with historical buildings, and historical indications of cracks in foundations associated with the historical buildings) in order to facilitate making predictions or identification for subsequent data (such as using the foundation pressure machine learning model 118 on new data captured by various sensors 104 associated with a building 101 order to determine a prediction of a crack in the foundation 103 of the building and/or the likelihood of a crack in the foundation 103 of the building 101).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques. Additionally or alternatively, supervised and/or unsupervised techniques may be followed by and/or otherwise used in conjunction with reinforced or reinforcement machine learning techniques.

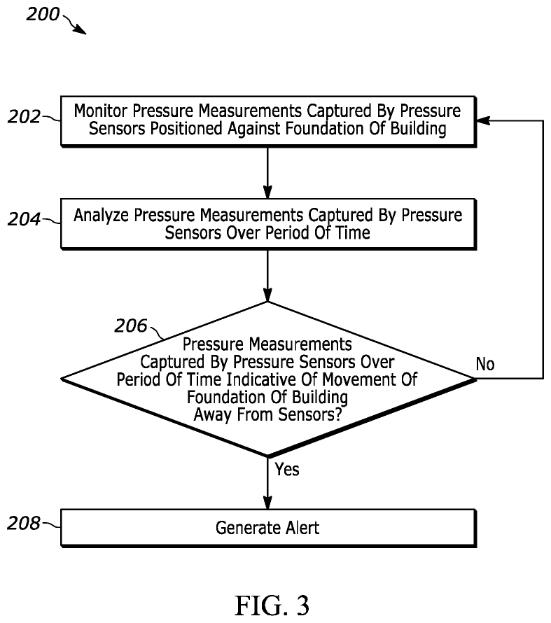

In addition, memories 114 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 114 may include instructions for carrying out any of the steps of the method 200 via an algorithm executing on the processors 112, which is described in greater detail below with respect to FIG. 3.

It should be appreciated that one or more other applications may be envisioned and that are executed by the processor(s) 112. It should be appreciated that given the state of advancements of mobile computing devices, all of the processes functions and steps described herein may be present together on a mobile computing device, such as the mobile computing device 106.

The mobile computing device(s) 106 may include, or may be configured to communicate with, a user interface 124, which may receive input from users and may provide audible or visible output to users. Additionally, the mobile computing device(s) 106 may include one or more processor(s) 126, as well as one or more computer memories 128. Memories 128 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 128 may store an operating system (OS) (e.g., iOS, Microsoft Windows, Linux, UNIX, etc.) capable of facilitating the functionalities, apps, methods, or other software as discussed herein. Memorie(s) 128 may also store a user application 130.

Executing the user application 130 may include, for instance, receiving alerts generated by the computing system 102 related to identified or predicted current or future cracks in the foundation 103 of a building 101, and providing audible and/or visible notifications associated with these alerts to a user, e.g., via the user interface 124 (e.g., via a mobile device alert, text message, email, voice alert, etc.). Moreover, in some examples, executing the user application 130 may include receiving input from a user related to actions to be taken by the computing system 102 and/or watering system 103 based upon alerts generated by the computing system 102 related to identified or predicted current or future cracks in the foundation 103 of a building 101. For instance, executing the user application 130 may include receiving input from a user indicating that one or more valves 109 should be opened or closed, and/or authorizing the opening or closing of the one or more valves 109 as recommended by the computing system 102.

In addition, memories 128 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 128 may include instructions for carrying out any of the steps of the method 200 via an algorithm executing on the processors 126, which is described in greater detail below with respect to FIG. 3. It should be appreciated that one or more other applications may be envisioned and that are executed by the processor(s) 126.

### Exemplary Computer-Implemented Method

FIG. 3 depicts a flow diagram of an exemplary computer-implemented method 200 for preventing cracks in the foundation of a home or other building, according to one embodiment. One or more steps of the method 200 may be implemented as a set of instructions stored on a computer-readable memory (e.g., memory 114 and/or memory 128) and executable on one or more processors (e.g., processor 112 and/or processor 126).

The method 200 may include monitoring (block 202) pressure measurements captured by pressure sensors positioned against a foundation of a building over a period of time. In some examples, the pressure sensors may be positioned in different locations around the perimeter of the foundation of the building and may be monitored individually or in zones based upon their locations.

The method 200 may further include analyzing (block 204) the pressure measurements captured by the pressure sensors over the period of time so that a determination (block 206) may be made as to whether the foundation of the building has moved away from the pressure sensors, and/or whether the ground adjacent to the foundation of the building has moved away from the pressure sensors over the period of time. In some examples, the determination may be a location-specific determination based upon the locations of particular pressure sensors associated with measurements indicative of the foundation and/or the ground moving away from the pressure sensors. For instance, the determination may be a determination that a particular portion of the foundation and/or the ground has moved away from pressure sensors positioned in particular locations over the period of time.

If no portion of the foundation of the building, and/or the ground adjacent to the foundation of the building has moved away from the pressure sensors over the period of time (block 206, NO), the method 200 may repeat from block 202 by continuing to monitor pressure measurements captured by the pressure sensors and analyzing the pressure measurements captured by the pressure sensors over time.

If the foundation (or a portion of the foundation) of the building and/or the ground adjacent to the foundation of the building has moved away from the pressure sensors over the period of time (block 206, YES), an alert may be triggered at block 206, indicating that the foundation of the building and/or the ground adjacent to the foundation of the building has moved away from the pressure sensors over the period of time. In examples in which a particular portion of the foundation and/or the ground is identified as having moved away from the pressure sensors over the period of time, the alert may indicate which portion of the foundation and/or the ground has moved away from the pressure sensors over the period of time. In some examples, triggering the alert may include generating a notification to be provided via a user interface of a mobile computing device associated with a user. For instance, the notification may include a visual depiction of the foundation, and may visually identify (i.e., in a spatially realistic manner) a portion of the foundation and/or the ground that has moved away from the pressure sensors over the period of time.

Additionally, in some examples, the method 200 may include controlling one or more valves associated with a watering system (e.g., a water hose, a sprinkler system, etc.) to open such that water is provided to the foundation of the building based upon the triggered alert. Furthermore, in some examples, the method 200 may include targeting the control of the one or more valves such that water is provided only to a particular portion of the foundation of the building that has been determined to have moved away from pressure sensors positioned in particular locations (and/or to a particular portion of the foundation of the building that is adjacent to a portion of ground that has been determined to have moved away from pressure sensors positioned in particular locations). For instance, the method 200 may include opening valves in locations associated with the particular portion of the foundation of the building, but closing valves in other locations.

Furthermore, in some examples, the method 200 may include accessing weather data associated with a region in which the building is located (e.g., from a publicly available weather database), or otherwise capturing weather data associated with a region in which the building is located (e.g., by interfacing with weather-related sensors in the region in which the building is located, such as temperature sensors, barometers, etc.). The method 200 may include analyzing the weather data to determine whether precipitation is predicted (and/or an amount of precipitation that is predicted) within a second period of time after the alert is triggered, and controlling the valves associated with the watering system based upon that determination. For instance, if rain is predicted (and/or if a certain amount of rain is predicted, e.g., greater than a threshold amount, such as 0.5 inch) in the region in which the building is located over a second period of time after the alert is triggered, the method 200 may include not opening the valves even when the alert is triggered, i.e., to conserve water, given that that the precipitation will already provide water to the foundation.

Additionally, in some examples, the method 200 may include receiving or capturing data captured by moisture sensors associated with the foundation of the building after the alert is triggered to determine an amount of moisture associated with the foundation of the building over a second period of time after the alert is triggered, and controlling the valves associated with the watering system based upon the amount of moisture associated with the foundation of the building. For instance, if greater than a threshold moisture level associated with the foundation of the building is detected, the method 200 may include not opening the valves even when the alert is triggered, and/or closing the valves after the threshold moisture level is reached, i.e., to conserve water, given that that there is already moisture present at the foundation of the building.

### Exemplary Computing System

FIG. 4 depicts an exemplary computing system 102 in which the techniques described herein may be implemented, according to one embodiment. The computing system 106 of FIG. 4 may include a computing device in the form of a computer 310. Components of the computer 310 may include, but are not limited to, a processing unit 320 (e.g., corresponding to the processor 112 of FIG. 1), a system memory 330 (e.g., corresponding to the memory 114 of FIG. 1), and a system bus 321 that couples various system components including the system memory 330 to the processing unit 320.

The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media.

Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 4 illustrates operating system 334, application programs 335 (e.g., corresponding to the foundation monitoring application 116 of FIG. 1), other program modules 336, and program data 337.

The computer 310 may also include other removable/non-removable, volatile/nonvolatile computer storage media. By way of example only. FIG. 4 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 4 provide storage of computer-readable instructions, data structures, program modules and other data for the computer 310. In FIG. 4, for example, hard disk drive 341 is illustrated as storing operating system 344, application programs 345, other program modules 346, and program data 347. Note that these components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a mobile computing device, personal computer, a server, a router, a network PC, a peer device or other common network node, and may include many or all of the elements described above relative to the computer 310, although only a memory storage device 381 has been illustrated in FIG. 4. The logical connections depicted in FIG. 4 include a local area network (LAN) 371 and a wide area network (WAN) 373 (e.g., either or both of which may correspond to the network 108 of FIG. 1), but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 4 illustrates remote application programs 385 as residing on memory device 381.

The techniques for preventing cracks in the foundation of a home or other building described above may be implemented in part or in their entirety within a computing system such as the computing system 102 illustrated in FIG. 4. In some such embodiments, the LAN 371 or the WAN 373 may be omitted. Application programs 335 and 345 may include a software application (e.g., a web-browser application) that is included in a user interface, for example.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing.” “computing.” “calculating.” “determining.” “presenting.” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises.” “comprising,” “includes.” “including,” “has.” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for preventing cracks in the foundation of a home or other building. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer system for preventing cracks in the foundation of a building, comprising:
one or more pressure sensors configured to be positioned against a foundation of a building;
one or more processors configured to interface with the one or more pressure sensors and one or more memories, the one or more memories storing non-transitory computer-readable instructions that, when executed by one or more processors, cause the one or more processors to:
monitor pressure measurements captured by the one or more pressure sensors over a period of time;
analyze the pressure measurements captured by the one or more pressure sensors over the period of time in order to determine that the foundation of the building has moved away from the one or more pressure sensors over the period of time; and
trigger an alert indicating that the foundation of the building has moved away from the one or more pressure sensors over the period of time.

2. The system of claim 1, wherein the processors are further configured to interface with the one or more valves associated with a watering system, and wherein the instructions, when executed by the one or more processors, further cause the one or more processors to:
control the one or more valves to open such that water is provided to the foundation of the building based upon the triggered alert.

3. The system of claim 2, wherein the watering system includes one or more of a water hose or a sprinkler system associated with the building.

4. The system of claim 2, wherein the one or more pressure sensors are each configured to be positioned at different locations with respect to the foundation of the building, wherein the one or more valves are each positioned at different locations with respect to the foundation of the building, and wherein the instructions, when executed by the one or more processors, further cause the one or more processors to:
analyze the pressure measurements captured by the one or more pressure sensors, and the locations at which each of the one or more pressure sensors are positioned, over the period of time in order to determine that a portion of the foundation of the building has moved away from one or more pressure sensors at particular locations over the period of time; and
trigger an alert indicating that the portion of the foundation of the building has moved away from the one or more pressure sensors at particular locations over the period of time,
wherein controlling the one or more valves to open such that water is provided to the foundation of the building based upon the triggered alert includes controlling one or more valves, positioned in locations corresponding to the portion of the foundation of the building that has moved away from the one or more pressure sensors, to open such that water is provided to the portion of the foundation of the building based upon the triggered alert.

5. The system of claim 2, wherein the instructions, when executed by the one or more processors, further cause the one or more processors to:
access weather data associated with a region in which the building is located; and
analyze the weather data to determine whether precipitation is predicted within a second period of time after the alert is triggered,
wherein controlling the one or more valves to open such that water is provided to the foundation of the building based upon the triggered alert is based upon whether precipitation is predicted within the second of time after the alert is triggered.

6. The system of claim 5, wherein the instructions, when executed by the one or more processors, further cause the one or more processors to:
analyze the weather data to determine an amount of precipitation that is predicted within the second period of time,
wherein controlling the one or more valves to open such that water is provided to the foundation of the building based upon the triggered alert is based upon whether the amount of precipitation that is predicted within the second period of time is greater than a threshold amount of precipitation.

7. The system of claim 2, wherein the one or more processors are further configured to interface with one or more moisture sensors associated with the foundation of the building, and wherein the instructions, when executed by the one or more processors, further cause the one or more processors to:
analyze data captured by the moisture sensors within a second period of time after the alert is triggered to determine an amount of moisture associated with the foundation of the building over the second period of time; and
wherein controlling the one or more valves to open such that water is provided to the foundation of the building based upon the triggered alert is based upon the amount of moisture associated with the foundation of the building over the second period of time.

8. The system of claim 1, wherein triggering the alert indicating that the foundation of the building has moved away from the one or more pressure sensors over the period of time includes generating a notification to be provided via a user interface of a mobile computing device associated with a user.

9. A non-transitory computer-readable medium storing instructions for preventing cracks in the foundation of a building, that, when executed by one or more processors configured to interface with one or more pressure sensors configured to be positioned against a foundation of a building, cause the one or more processors to:
monitor pressure measurements captured by the one or more pressure sensors over a period of time;
analyze the pressure measurements captured by the one or more pressure sensors over the period of time in order to determine that the foundation of the building has moved away from the one or more pressure sensors over the period of time; and
trigger an alert indicating that the foundation of the building has moved away from the one or more pressure sensors over the period of time.

10. The non-transitory computer-readable medium of claim 9, wherein the processors are further configured to interface with the one or more valves associated with a watering system, and wherein the instructions, when executed by the one or more processors, further cause the one or more processors to:
control the one or more valves to open such that water is provided to the foundation of the building based upon the triggered alert.

11. The non-transitory computer-readable medium of claim 10, wherein the watering system includes one or more of a water hose or a sprinkler system associated with the building.

12. The non-transitory computer-readable medium of claim 10, wherein the one or more pressure sensors are each configured to be positioned at different locations with respect to the foundation of the building, wherein the one or more valves are each positioned at different locations with respect to the foundation of the building, and wherein the instructions, when executed by the one or more processors, further cause the one or more processors to:
analyze the pressure measurements captured by the one or more pressure sensors, and the locations at which each of the one or more pressure sensors are positioned, over the period of time in order to determine that a portion of the foundation of the building has moved away from one or more pressure sensors at particular locations over the period of time; and
trigger an alert indicating that the portion of the foundation of the building has moved away from the one or more pressure sensors at particular locations over the period of time,
wherein controlling the one or more valves to open such that water is provided to the foundation of the building based upon the triggered alert includes controlling one or more valves, positioned in locations corresponding to the portion of the foundation of the building that has moved away from the one or more pressure sensors, to open such that water is provided to the portion of the foundation of the building based upon the triggered alert.

13. The non-transitory computer-readable medium of claim 10, wherein the instructions, when executed by the one or more processors, further cause the one or more processors to:
access weather data associated with a region in which the building is located; and
analyze the weather data to determine whether precipitation is predicted within a second period of time after the alert is triggered,
wherein controlling the one or more valves to open such that water is provided to the foundation of the building based upon the triggered alert is based upon whether precipitation is predicted within the second of time after the alert is triggered.

14. The non-transitory computer-readable medium of claim 13, wherein the instructions, when executed by the one or more processors, further cause the one or more processors to:
analyze the weather data to determine an amount of precipitation that is predicted within the second period of time,
wherein controlling the one or more valves to open such that water is provided to the foundation of the building based upon the triggered alert is based upon whether the amount of precipitation that is predicted within the second period of time is greater than a threshold amount of precipitation.

15. The non-transitory computer-readable medium of claim 10, wherein the one or more processors are further configured to interface with one or more moisture sensors associated with the foundation of the building, and wherein the instructions, when executed by the one or more processors, further cause the one or more processors to:
analyze data captured by the moisture sensors within a second period of time after the alert is triggered to determine an amount of moisture associated with the foundation of the building over the second period of time; and
wherein controlling the one or more valves to open such that water is provided to the foundation of the building based upon the triggered alert is based upon the amount of moisture associated with the foundation of the building over the second period of time.

16. The non-transitory computer-readable medium of claim 9, wherein triggering the alert indicating that the foundation of the building has moved away from the one or more pressure sensors over the period of time includes generating a notification to be provided via a user interface of a mobile computing device associated with a user.

17. A computer-implemented method for preventing cracks in the foundation of a building, comprising:
monitoring, by one or more processors, pressure measurements captured by one or more pressure sensors configured to be positioned against a foundation of a building over a period of time;
analyzing, by the one or more processors, the pressure measurements captured by the one or more pressure sensors over the period of time in order to determine that the foundation of the building has moved away from the one or more pressure sensors over the period of time; and
triggering, by the one or more processors, an alert indicating that the foundation of the building has moved away from the one or more pressure sensors over the period of time.

18. The computer-implemented method of claim 17, further comprising:
controlling, by the one or more processors, one or more valves associated with a watering system to open such that water is provided to the foundation of the building based upon the triggered alert.

19. The computer-implemented method of claim 18, wherein the watering system includes one or more of a water hose or a sprinkler system associated with the building.

20. The computer-implemented method of claim 18, further comprising:
analyzing, by the one or more processors, the pressure measurements captured by the one or more pressure sensors, and locations at which each of the one or more pressure sensors are positioned, over the period of time in order to determine that a portion of the foundation of the building has moved away from one or more pressure sensors at particular locations over the period of time; and
triggering, by the one or more processors, an alert indicating that the portion of the foundation of the building has moved away from the one or more pressure sensors at particular locations over the period of time,
wherein controlling the one or more valves to open such that water is provided to the foundation of the building based upon the triggered alert includes controlling one or more valves, positioned in locations corresponding to the portion of the foundation of the building that has moved away from the one or more pressure sensors, to open such that water is provided to the portion of the foundation of the building based upon the triggered alert.

21.
